(19) United States
(12) Patent Application Publication
(10) Pub. No.: US 2009/0027902 A1
(43) Pub. Date: Jan. 29, 2009

(54) DECK-BOX FOR USE WITH UNDERWATER SWIMMING POOL LIGHT

(75) Inventors: Allan Fielding, Brighouse (GB); Douglas Burnham, Leeds (GB)

Correspondence Address: CONNOLLY BOVE LODGE & HUTZ LLP, 1875 EYE STREET, N.W., SUITE 1100, WASHINGTON, DC, 20006, US

(73) Assignee: APPLEYARD LEES, Halifax (GB)

(21) Appl. No.: 11/573,031

(22) PCT Filed: Aug. 4, 2005
(86) PCT No.: PCT/GB05/02997

§ 371 Date: Oct. 2, 2007

(30) Foreign Application Priority Data
Aug. 4, 2004 (GB) 0417438.9

(51) Int. Cl. F21V 17/00

(52) U.S. Cl. 362/375

(57) ABSTRACT

The invention relates to improvements to swimming pools, in particular to providing extra facilities to a deck box, such as those commonly used to provide power to underwater swimming pool lights. The improvement comprises the provision of a facility to illuminate the lid area of a deck box, by providing an internal light source and a lid which may be translucent or transparent. The invention also extends to providing a kit of parts for converting an existing deck box into a deck box in accordance with the teachings of the invention.

The present invention concerns a deck box for a swimming pool.

Many swimming pools incorporate lighting, usually underwater lighting, for which an electrical supply is necessary. Typically, the electrical supply is provided underground from an adjacent building, with an access point known as a deck box (usually water proof) adjacent the swimming pool. Often in fact multiple deck boxes are provided scattered around the perimeter of the swimming pool providing electrical connection points for individual underwater swimming pool lights.

A typical procedure for constructing a swimming pool and providing underwater lighting involves providing a niche, or receptor, within the perimeter wall of a swimming pool during construction, into which niche, a “guts assembly” made up of the light proper attached to an umbilical supply cable is inserted. This umbilical supply cable is then later on, possibly during back-filling around the perimeter walls, relayed via a conduit to an adjacent deck box near the pool edge. In this way, maintenance/replacement of the guts assembly can be carried out by firstly isolating power to the swimming pool lights then physically disconnecting the umbilical cable at the deck box and then retrieving the light/guts assembly from the swimming pool.

Another method of construction which is disclosed in patent application PCT/GB00/00002, by the present inventors, discloses an improved system in which lights may be inspected and replaced directly from a deck box area, without requiring maintenance operatives to enter the pool, or to drain the pool to retrieve the guts assembly.

A typical deck box (whether it is for a swimming pool light, or for other pool side apparatus such as a camera, speaker unit etc.) may resemble an electrical junction box and might stand proud of the surrounding surface of the swimming pool. Alternatively, in more pleasing designs, the bulk of the deck box is submerged within the area around the pool with a flush-fitting lid. However, whatever type of deck box is employed, they are generally not particularly aesthetically pleasing.

Swimming pools inherently have a number of safety problems associated with them. In particular, to help reduce the chances of accidentally stumbling into a pool, some means of defining the edge of a pool area and making it stand out, particularly at night, would be desirable. Generally, add-on lighting solutions showing the pool area perimeter involve providing extra lighting units scattered around the edge of the pool or elsewhere (e.g. on overhead gantries or on posts). Each of these lighting units requires an electrical supply being provided to it, or some battery supply needs to be provided.

Post mounted surround lighting has to be sufficiently far away from the pool edge not to form a physical hazard.

It is an aim of embodiments of the present invention to provide an improved lighting system for defining the perimeter swimming pool.

It is another aim of embodiments of the invention to provide means for visually enhancing swimming pool deck boxes.

A further aim of embodiments is to provide a kit of parts for adapting an existing deck box to incorporate illumination.

According to a first aspect of the invention there is provided a deck box for a swimming pool, the deck box comprising an electrical junction box for providing electrical power to pool-side apparatus, the deck box being characterised by further comprising a light source for illuminating a lid area of the deck box, power for the light source being provided by the deck box.

Power for the light source may be provided by a direct connection to a power supply already present at the deck box, or under control of a control unit resident within the deck box (in which case, said control unit may also be used to control the pool-side apparatus). In another alternative, power for the light source may be provided under control of a dedicated control unit for controlling illumination of the light source and any related equipment.

Preferably, the deck box comprises a transparent or translucent lid.

The lid area may be illuminable to provide one or more visual signals, such as markings formed on an illuminable area of the lid.

Alternatively, visual signals may be provided by configuring a power signal applied to the light source. For instance, the light source may comprise a matrix display of selectively illuminable elements.

The lid may have one or more colourings applied to it.

The visual signals or markings may indicate a safe pedestrian area or an unsafe pedestrian area. Alternatively, such signals/markings might provide a visual signal such as an arrow pointing to the nearest safe route of exit. In another variation, a lighting effect provided at the deck box may provide an indication as to the health or status of other electrical equipment connected to the deck box. For instance, if the deck box provides an electrical supply to a submerged pool light, the deck box lid might provide a first lighting effect if the submerged pool light is broken, or a second lighting effect if it is intact. In this way, an indication of health of other electrical systems may be provided.

Preferably, the deck box is provided with a proximity sensor. In a proximity activated mode, the deck box may be arranged to illuminate upon the approach of a person.

In other preferred arrangements, the deck box may include an audible sounding device activated by a proximity sensor to warn approaching persons of near pool edge hazard.

The deck box may comprise a sensor for use in conjunction with remote control apparatus.

The deck box may further include one or more elements providing an extension to an alarm system. For instance, the fight source of the deck box may be triggered to illuminate under an alarm condition,

The deck box may be provided with a communications interface for communicating with one or more other deck boxes. The communications interface may be used to provide activation signals to control light sources within the deck boxes and/or, to control the pool-side apparatus.

The deck box may comprise a memory. The memory may record event data. The memory may be arranged to be a data logger. The memory may store details relating to activity of persons near the deck box, alarm conditions, fault conditions, etc.

The deck box may have an associated microphone to enable remote monitoring, such as surveillance, which could be linked to an alarm function. Alternatively/additionally the microphone may be utilised to enable communications from the communications interface to another location such as another deck box area, or any other third party location. Voice recognition software may be provided within the controller to enable voice commands received through the microphone to be implemented at the deck box—such as lights on, lights off, lights down/up etc., etc.

The control unit may be arranged for communicating with a remote/external control system such as a computer system. Such communication is preferably handled by the communications interface, and/or may be linked to/via a telephone network and/or the internet.

A master control unit may be provided for controlling the operation of one or more functions of a plurality of deck boxes.

Components in the deck box may be plug/socket fixing for easy upgrading or replacing. Upgrades to the control unit and/or the communications interface may be made when more or better functions are required. The plug/socket fixings may be applied to an entire lid assembly, by e.g. providing a lid with pins and a base assembly with receiving sockets. Automatic power disconnection on separation of component parts may be provided.

According to a second aspect of the invention, there is provided a kit of parts for converting an existing deck box, the kit of parts comprising a lid, a light source for illuminating the lid, and means for conveying power for the light source to the light source from the deck box.

A kit of parts of the second aspect may comprise any of the preferred features of the deck box of the first aspect in any logical combination.

For a better understanding of the invention, and to show how embodiments of the same may be carried into effect, reference will now be made, by way of example, to the accompanying diagrammatic drawings in which:

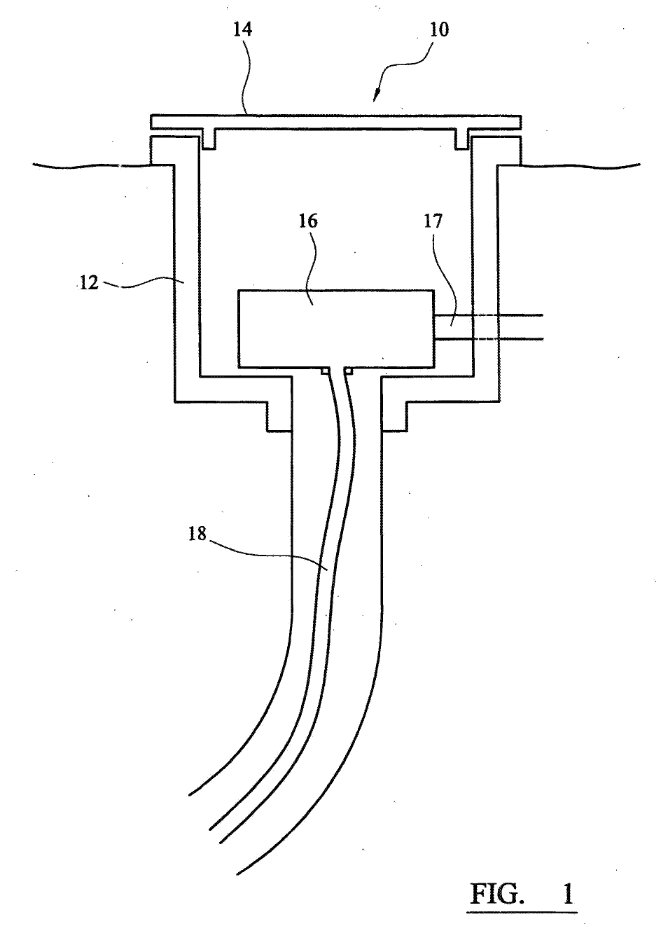

FIG. 1 shows a prior art deck box;

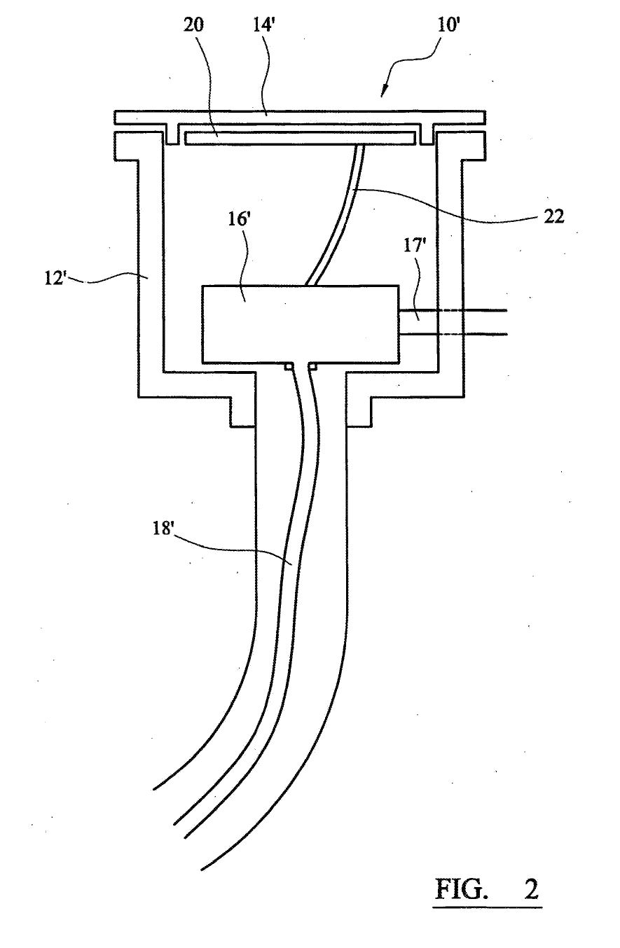

FIG. 2 shows a first embodiment of a deck box in accordance with the present invention;

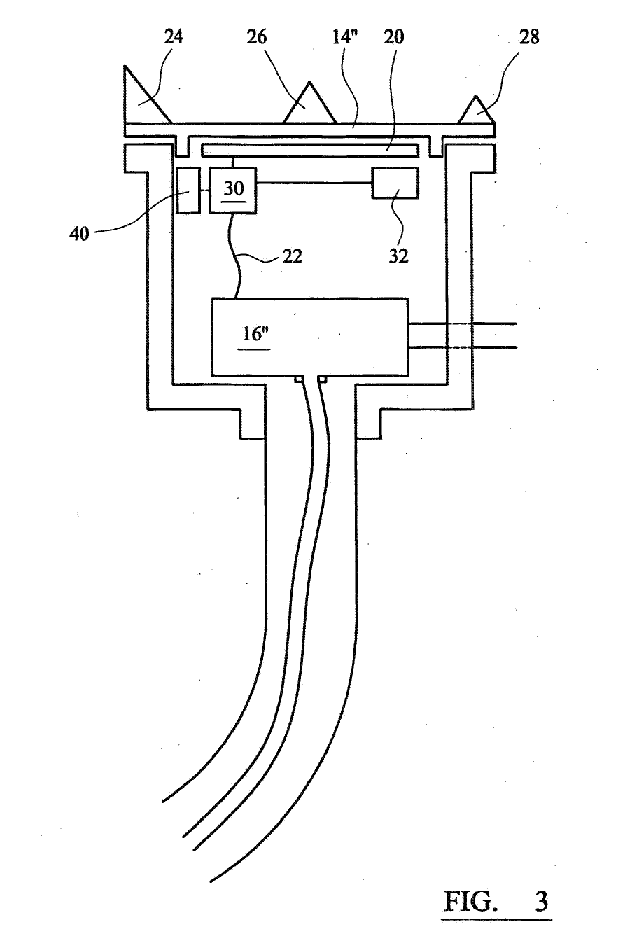

FIG. 3 shows a second embodiment of a deck box in accordance with the present invention; and

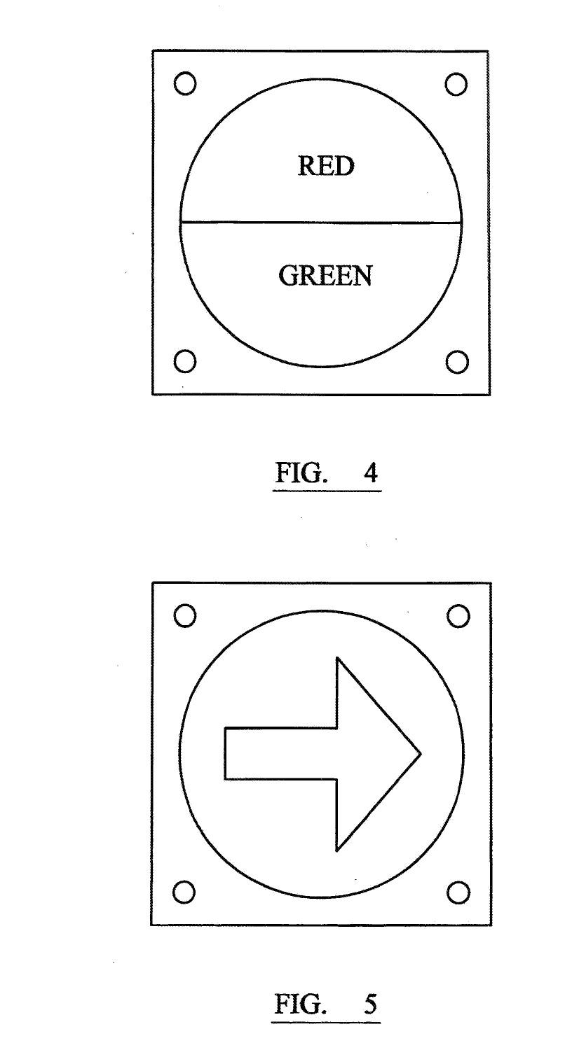

FIGS. 4 and 5 show examples of markings carried by a lid of a deck box in accordance with embodiments of the invention.

FIG. 1 shows a typical prior art deck box 10. The deck box 10 comprises casing 12 with an associated lid 14, it houses a lighting connector which forms a rudimentary type of controller 16 in that it receives an external electricity supply 17 and provides power to a lighting unit (not shown) via power cord 18. Typically, the deck box is provided adjacent a pool side area and the lighting unit will be a submerged pool light.

In FIG. 2, there is shown a modified deck box 10′ in accordance with an aspect of the invention. Here, like numerals indicate like components to the elements of FIG. 1. It will be noted that in this case there is provided a light source 20 attached to, or close to lid 14′ and power is fed to the light source 20 via electrical connection 22. Here, the lid 14′ is a transparent or translucent lid, manufactured or adapted to cooperate with the casing 12′ in a similar way to the manner in which the (normally opaque) lid 14 of FIG. 1 cooperates with the casing 12. The electrical connection 22 is simply effected by making a branch connection at the controller 16′ and, in its simplest form, the controller 16′ can be a connector forming a control unit for the light source 20 and such light source 20 may be illuminated at the same time as the ordinary swimming pool light (not shown) fed by electrical cable 18′ is illuminated.

Operation of the embodiment shown in FIG. 2 is extremely straightforward, as is implementation of that embodiment. Essentially, any existing deck box may be modified to include an internal light source by providing an adapted lid 14′, within which or with which a light source 20 is accommodated or associated and the electrical connection is simply made at the deck box by making an attachment to the power lead 18′ leading to the swimming pool Light.

FIG. 3 shows a more sophisticated version of illuminated deck box in which, in addition to the components already described in relation to the FIG. 2 embodiment, there is provided a proximity sensor 24, a daylight sensor 26, a sensor for a remote control connection 28, a dedicated control unit 30, a speaker unit 32 and a communications module 40. Here, the electrical connection 22 is preferably made to be a permanent connection direct to the main supply 17, rather than being switched by the controller 16″, such that the control unit 30 may itself be permanently powered and route power to the various components (light source 20, sensors 24-26, speaker unit 32 and communications module 40) as and when required under any operational mode.

Here, the control unit 30 receives inputs from the proximity sensor 24, the daylight sensor 26, and the remote control sensor 28 and according to any desired programming modes controls operation of the light source 20 and (optional) speaker 32.

The (optional) communications module 40 provides the capability of interaction of a plurality of deck boxes (as described later). Also, the addition of a microphone (not shown) may add benefits as evident from the text which follows.

Operation of the deck box of FIG. 3 and some examples of different programming modes will now be described.

### Safety Mode

In a safety mode of operation, the deck box and its sensors can be used to detect activity near the edge of the pool and warn of a near edge hazard condition. For instance, at night, when it is not necessarily desired to illuminate the pool edge area permanently, the safety mode may be initiated in which proximity sensor 24 is arranged to detect any approaching person. Upon detection of a persons, a signal is sent by the proximity sensor 24 to the control unit 30 which is then arranged to illuminate the light source 20 in any chosen manner (for instance, flashing or permanent illumination) and the speaker unit 32 may be triggered to issue an audible warning.

If the communications module 40 is fitted and communication between deck boxes enabled, then the control unit 30 may send (and receive) notification (and from) other deck boxes regarding the approach of a person and cause all deck boxes in the area to illuminate their light sources 20.

### Programming Mode

The control unit 30 has a programming mode in which it may be either programmed locally (i.e. at the deck box itself) or remotely. Remote programming may be accomplished via the remote control sensor 28 and may be used to set a particular operational mode. For instance, the safety mode already described, or a permanently on mode, or a permanently off mode, a lighting effect (such as a (cyclically increasing/decreasing intensity or pattern of illumination) or to work only during night time hours (for instance by use in conjunction with the daylight sensor 26).

Further, by provision of the communications module 40 a programming mode request picked up at one deck box (i.e. the box closest to the hand held remote control) may be relayed to all other deck boxes.

A microphone may be provided which enables voice communications from the communications module 40 to another location such as another deck box area, or any other third party location. Further, voice recognition software may be provided within the control unit 30 to enable) voice commands received through such a microphone to be programmed in directly or directly implemented at the deck box—such as lights on, lights off, lights down/up etc., etc.

### Alarm Mode

The light source 20 and speaker 32 may be used in conjunction with an alarm system. For instance, if linked into a fire alarm system, the deck box and other neighbouring deck boxes may be arranged to illuminate. In fact, selected deck boxes can be used with this feature so that a path to safety might be shown. Alternatively, the illumination may simply be used to define the pool edge in the alarm mode, so that in a smoky atmosphere people can avoid stumbling into the pool. Also, the speaker unit 32 may be arranged to permit an alarm message.

The deck box may have an associated microphone to enable remote monitoring, such as surveillance which could be linked to the alarm function.

### Failure Alert Mode

In this mode, the light source 20 may be used to signal the fact that there has been a failure of an associated local electrical system. For instance, a swimming pool light directly controlled by the controller 16″ may be signalled by making the associated light source 20 within the same deck box flash. This will then alert maintenance staff to attend to the fault.

While a number of different operational modes have been described above, it will be appreciated by the skilled man that any number of other desired features may be provided.

Further, whilst a hand-held remote control has been described as being utilised for programming, or controlling of deck boxes, it will be realised that a wired controller is within the scope of the invention.

In other variations, an individual deck box and its associated light unit controller 30 may control other lights around the pool area. For instance, illumination of a deck box might trigger illumination at a nearby seating area, or bar area. Also, individual deck boxes may be provided with the capacity for recording event data. In this regard, a real time clock, associated with an event memory may be provided for recording activity of personas near the deck box, or other events such as alarm conditions, fault conditions etc. This event memory may later be interrogated by a user, such as a maintenance person.

Referring now to FIGS. 4 and 5, examples of markings provided on the lid portions 14′, 14″ are shown.

In FIG. 4, an effect is provided in which half the lid portion is coloured red, whilst the other half is coloured green. By aligning the lid such that the red portion is nearest to the pool edge, a safe zone and a hazard zone may be indicated.

In FIG. 5, a directional marking in the form of an arrow is shown. This directional marking may be used in order to direct pedestrians toward the nearest exit in the event of an emergency.

It will be appreciated that any appropriate, or aesthetically pleasing display, may be chosen. Also, it will be evident to the skilled man that means for changing logos or displays may be provided. In a most simple arrangement, the markings may be changed manually according to a user's desire, whilst more complex arrangements may involve a change in display under the control of the control unit 30. For instance, slide capabilities may be provided within the deck box, a particular slide being chosen according to a particular condition present at the deck box, or a programming mode selected to impose a variable display onto the lid. In other alternatives, visual signals may be varied by incorporating a LED light or matrix type arrangement as the light source, the LED being or matrix being selectably energisable to give different colourings and/or visual signals as desired. In this way, different moods may be created or different functions carried out.

Components in the deck box may be plug/socket fixing for easy upgrading or replacing. Upgrades to the control unit and/or the communications interface may be made when more or better functions are required. The plug/socket fixing may be applied to an entire lid assembly by e.g. providing a lid with pins and a base assembly with receiving sockets. Automatic power disconnection on separation of component parts may be provided.

The control unit 30 may be arranged for communicating with a remote/external control system, such as a computer system. Such communication is preferably handled by the communications module 40, and/or may be linked to/via a telephone network and/or the internet.

The skilled man will realise that whenever wired connections are referred to they may where appropriate, be replaced by wire free connections. Such connections may be by radio wave transmission, induction or any other appropriate means. Power may also be provided by inductive connection.

Also, while not shown or explicitly stated above, the deck box is generally water proof thus the lid will have seals associated with it to communicate with body.

From the foregoing description it will be evident to the skilled man that the invention encompasses conversions to existing deck boxes, as well as the provision of completely new deck boxes having the inventive features. In respect of conversions, a typical conversion kit will comprise a replacement lid and sub-chassis assembly associated with the lid and carrying the light source and control units etc.

Attention is directed to all papers and documents which are filed concurrently with or previous to this specification in connection with this application and, which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A deck box for a swimming pool, the deck box comprising:
an electrical junction box for providing electrical power to pool-side apparatus; and
a light source for illuminating a lid area of the deck box, power for the light source to be provided by the deck box.

2. A kit of parts for converting an existing deck box for providing electrical power to pool-side apparatus, the kit of parts comprising:
a lid,
a light source for illuminating the lid, and
means for conveying power for the light source from the deck box.

3. (canceled)

4. A box according to claim 1, wherein power for the light source is provided under control of a control unit resident within the deck box, said control unit being also used to control the pool-side apparatus.

5.-7. (canceled)

8. The box of claim 1, wherein the lid area is illuminable to provide one or more visual signals.

9. The deck box of claim 8, wherein the one or more visual signals comprise markings formed on an illuminable area of the lid.

10. (canceled)

11. The deck box of claim 1, wherein the light source comprises a matrix of selectively illuminable elements.

12.-13. (canceled)

14. The box of claim 1, wherein a lighting effect provided at the deck box is to provides an indication as to health or status of other electrical equipment connected to the deck box.

15. The box of claim 14, wherein the deck box is adapted to provide an electrical supply to a submerged pool light, and wherein the deck box lid is adapted to provides a first lighting effect if the submerged pool light is in need of attention, or a second lighting effect if it is intact.

16. (canceled)

17. The box of claim 1, wherein the deck box further comprises a proximity sensor, wherein in a proximity activated mode, one or more controlled components are arranged to react to the approach of a person.

18.-19. (canceled)

20. The box of claim 1, wherein the deck box comprises a sensor for use in conjunction with remote control apparatus, wherein the box is adapted to be activated to perform a plurality of functions via said sensor and remote control apparatus.

21. (canceled)

22. The box of claim 20, wherein said functions include one or more programming functions.

23. The box of claim 22, further comprising a timer and memory which to provide timer based operation.

24. The box of claim 1, further comprising one or more elements to provide an extension to an alarm system.

25. (canceled)

26. The box of claim 1, further comprising a communications interface for communicating with one or more other deck boxes.

27.-32. (canceled)

33. A kit according to claim 2, wherein power for the light source is provided under control of a control unit resident within the deck box, said control unit being also used to control the pool-side apparatus.

34. The kit of claim 2, wherein the lid is illuminable to provide one or more visual signals.

35. The kit of claim 34, wherein the one or more visual signals comprise markings formed on an illuminable area of the lid.

36. The kit of claim 2, wherein the light source comprises a matrix of selectively illuminable elements.

37. The kit of claim 2, wherein a lighting effect provided by the kit is to provide an indication as to health or status of other electrical equipment connected to the deck box.

38. The kit of claim 2, wherein the deck box is adapted to provide an electrical supply to a submerged pool light, and wherein the lid is adapted to provide a first lighting effect if the submerged pool light is in need of attention, or a second lighting effect if it is intact.

39. The kit of claim 2, further comprising a proximity sensor, wherein in a proximity activated mode, one or more controlled components are arranged to react to the approach of a person.

40. The kit of claim 2, further comprising a sensor for use in conjunction with remote control apparatus, wherein the deck box is adapted to be activated to perform a plurality of functions via said sensor and remote control apparatus.

41. The kit of claim 40, wherein said functions include one or more programming functions.

42. The kit of claim 41, further comprising a timer and memory to provide timer based operation.

43. The kit of claim 2, further comprising one or more elements to provide an extension to an alarm system.

44. The kit of claim 2, further comprising a communications interface for communicating with one or more other deck boxes.
